(19) United States
(12) Patent Application Publication
(10) Pub. No.: US 2014/0113184 A1
(43) Pub. Date: Apr. 24, 2014

(54) THREE-DIMENSIONAL NON-RECTANGULAR BATTERY CELL STRUCTURES

(71) Applicant: Apple Inc., Cupertino, CA (US)

(72) Inventors: Bradley J. Hamel, Redwood City, CA (US); Emery A. Sanford, San Francisco, CA (US); John Raff, Menlo Park, CA (US); Richard H. Dinh, Saratoga, CA (US); Ron A. Hopkinson, Campbell, CA (US); Richard M. Mank, Cupertino, CA (US)

(73) Assignee: Apple Inc., Cupertino, CA (US)

(21) Appl. No.: 13/902,336

(22) Filed: May 24, 2013

Related U.S. Application Data
(60) Provisional application No. 61/715,436, filed on Oct. 18, 2012.

(51) Int. Cl. H01M 2/02; H01M 2/06

(52) U.S. Cl. CPC H01M 2/0202; H01M 2/06
USPC 429/179; 429/163

(57) ABSTRACT

The disclosed embodiments provide a battery cell. The battery cell includes a set of layers including a cathode with an active coating, a separator, and an anode with an active coating. The battery cell also includes a pouch enclosing the layers. Finally, the battery cell has a three-dimensional non-rectangular shape to facilitate efficient use of space within a portable electronic device powered by the battery cell.

### RELATED APPLICATION

This application claims priority under 35 U.S.C. §119 to U.S. Provisional Application No. 61/715,436, entitled “Three-Dimensional Non-Rectangular Battery Cell Structures,” by the same inventors, filed 18 Oct. 2012 (Atty. Docket No.: APL-P16899USP1), the contents of which are herein incorporated by reference in their entirety.

### BACKGROUND

1. Field

The disclosed embodiments relate to batteries for portable electronic devices. More specifically, the disclosed embodiments relate to battery cells with three-dimensional non-rectangular shapes that facilitate efficient use of space within portable electronic devices by accommodating components in the portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries typically include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

However, efficient use of space may be limited by the use and arrangement of cells in existing battery pack architectures. In particular, battery packs typically contain rectangular cells of the same capacity, size, and dimensions. The physical arrangement of the cells may additionally mirror the electrical configuration of the cells. For example, a common six-cell battery pack may include six lithium-polymer cells of the same size and capacity configured in a two in series, three in parallel (2s3p) configuration. Within such a battery pack, two rows of three cells placed side-by-side may be stacked on top of each other; each row may be electrically coupled in a parallel configuration and the two rows electrically coupled in a series configuration. Consequently, the battery pack may require space in a portable electronic device that is at least the length of each cell, twice the thickness of each cell, and three times the width of each cell.

Moreover, this common type of battery pack design may be unable to utilize free space in the portable electronic device that is outside of a rectangular space reserved for the battery pack. For example, a rectangular battery pack of this type may be unable to efficiently utilize free space that is curved, rounded, and/or irregularly shaped. Along the same lines, other components in the portable electronic device may be laid out and/or designed in a way that accommodates the battery pack. For example, a battery-management unit (BMU) may be attached to the side of the battery pack, thus protruding outside the rectangular space occupied by the battery pack.

Hence, the use of portable electronic devices may be facilitated by improvements related to the packaging efficiency, capacity, form factor, design, and/or manufacturing of battery packs containing lithium-polymer battery cells.

### SUMMARY

The disclosed embodiments provide a battery cell. The battery cell includes a set of layers including a cathode with an active coating, a separator, and an anode with an active coating. The battery cell also includes a pouch enclosing the layers. Finally, the battery cell has a three-dimensional non-rectangular shape to facilitate efficient use of space within a portable electronic device powered by the battery cell.

In some embodiments, the non-rectangular shape includes a hole extending through both the layers and the pouch, a recess formed along a surface of the battery cell, and/or a notch formed along one or more sides of the battery cell. The non-rectangular shape may also include a set of electrode sheets of different dimensions arranged in a stacked configuration, with a curve formed in the electrode sheets.

In some embodiments, the battery cell also includes a first conductive tab coupled to the cathode and a second conductive tab coupled to the anode, wherein the first and second conductive tabs extend through seals in the pouch to provide terminals for the battery cell.

In some embodiments, the first and second conductive tabs are positioned within the hole, recess, and/or notch.

In some embodiments, the non-rectangular shape accommodates a component in the portable electronic device. For example, the notch, hole, and/or recess may fit a battery-management unit (BMU), printed circuit board (PCB), and/or electromagnetic shielding for the BMU and/or PCB. The conductive tabs may also be located in or near the notch, hole, and/or recess to facilitate coupling of the battery cell to the component and/or other battery cells in the portable electronic device.

In some embodiments, the hole and/or recess are associated with a square shape, a rectangular shape, a circular shape, and/or an oval shape.

In some embodiments, the recess forms a channel that extends across a length of the battery cell.

In some embodiments, the set of layers forms a cell stack having an outermost cathode layer which is exposed against the pouch.

### BRIEF DESCRIPTION OF THE FIGURES

FIG. 1A illustrates a battery cell in accordance with the disclosed embodiments.

FIG. 1B illustrates a battery cell in accordance with the disclosed embodiments.

FIG. 2 illustrates a battery cell in accordance with the disclosed embodiments.

FIG. 3 illustrates a battery cell in accordance with the disclosed embodiments.

FIG. 4A illustrates a battery cell in accordance with the disclosed embodiments.

FIG. 4B illustrates a battery cell in accordance with the disclosed embodiments.

FIG. 5A illustrates a battery cell in accordance with the disclosed embodiments.

FIG. 5B illustrates a battery cell in accordance with the disclosed embodiments.

FIG. 6 illustrates a portable electronic device in accordance with the disclosed embodiments.

FIG. 7A illustrates an exemplary set of layers in a battery cell in accordance with the disclosed embodiments.

FIG. 7B illustrates an exemplary set of layers in a pouch for a battery cell in accordance with the disclosed embodiments.

FIG. 7C illustrates how cracking can occur in a polypropylene layer close to a corner of cell stack in accordance with the disclosed embodiments.

FIG. 7D illustrates different surfaces of a non-rectangular cell stack in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments relate to the design of a battery cell, which includes a set of layers enclosed in a pouch. The layers may include a cathode with an active coating, a separator, and an anode with an active coating. The layers may be stacked and/or wound to create a jelly roll, bi-cell, and/or other type of battery structure. The battery cell also includes a first conductive tab coupled to the cathode and a second conductive tab coupled to the anode. The first and second conductive tabs extend through seals in the pouch to provide terminals for the battery cell.

In addition, the battery cell may have a three-dimensional non-rectangular shape and/or design. The term “non-rectangular” can mean that the battery cell is not rectangular through any cutting plane, or in other words, that the battery cell is not rectangular when viewed from the top, bottom, and/or sides. The non-rectangular shape and/or design may facilitate efficient use of space within the portable electronic device by, for example, accommodating a component in the portable electronic device and/or a curved enclosure for the portable electronic device. In turn, the battery cell may provide greater capacity, packaging efficiency, and/or voltage than rectangular battery cells in the same portable electronic device.

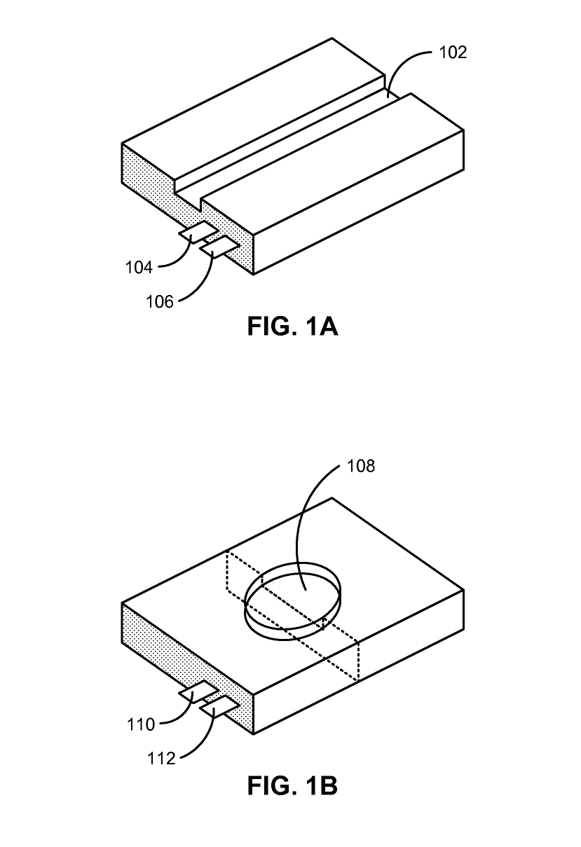

As shown in FIG. 1A, the battery cell may include a recess 102 along a surface of the battery cell. Recess 102 may form a channel that extends along a length of the battery cell. In turn, recess 102 may accommodate a component in the portable electronic device, such as a printed circuit board (PCB), battery-management unit (BMU), and/or electromagnetic shielding for the component.

The battery cell may also include a set of conductive tabs 104-106 extending through seals in the pouch enclosing the battery cell. Conductive tabs 104-106 may be used to electrically couple the battery cell with one or more other battery cells to form a battery pack. For example, conductive tab 104 may be coupled to the cathode of the battery cell, and conductive tab 106 may be coupled to the anode of the battery cell. Conductive tabs 104-106 may also be coupled to other battery cells in a series, parallel, or series-and-parallel configuration to form the battery pack. Conductive tabs 104-106 may be located near and/or within recess 102 to facilitate the coupling of the battery cell to the component residing in recess 102, such as a BMU.

Alternatively, as shown in FIG. 1B, the battery cell may include a circular and/or oval recess 108. Recess 108 may accommodate a component that is shaped differently from the component accommodated by recess 102 of FIG. 1A. For example, recess 108 may accommodate a portion of an enclosure for the portable electronic device.

Those skilled in the art will appreciate that recesses of different shapes and sizes may be formed in the battery cell. For example, the battery cell may include a recess that is rectangular, square, circular, and/or oval to accommodate a variety of components and/or structures within the portable electronic device.

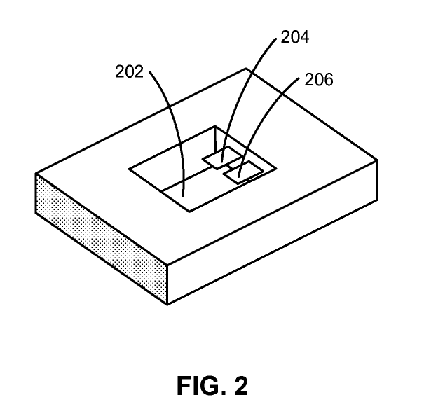

The battery cell may also include other non-rectangular features. As shown in FIG. 2, the battery cell may include a hole 202 that extends through both the layers and the pouch instead of a recess with a depth that is shallower than the thickness of the battery cell. As with the recesses described above, hole 202 may be rectangular, square, circular, oval, and/or any other shape that facilitates efficient use of space within the portable electronic device.

Hole 202 may allow a component to be placed through the middle of the battery cell and/or other battery cells stacked along the top or bottom of the battery cell. For example, a BMU connecting the battery cells may run through hole 202 and/or similar holes in the other battery cells. Moreover, a set of conductive tabs 204-206 may be placed within hole 202 to facilitate coupling of the battery cell to the BMU and/or other battery cells.

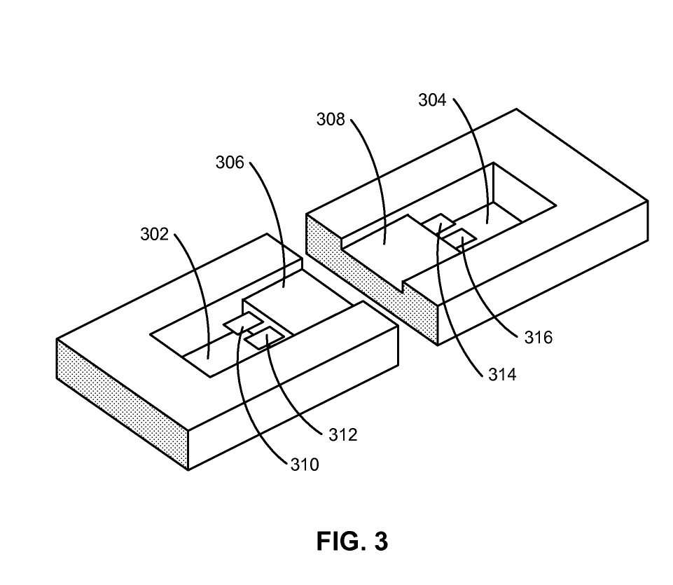

The above-described non-rectangular features may also be combined in the battery cell. As shown in FIG. 3, two battery cells may be positioned adjacent to one another and include both holes 302-304 and recesses 306-308. For example, one battery cell may include a rectangular and/or square hole 302 and recess 306 extending to the right from hole 302, and another battery cell may include a rectangular and/or square hole 304 and recess 308 extending to the left from hole 304.

Such combinations of holes 302-304 and recesses 306-308 may allow the battery cells to accommodate a component in the portable electronic device. For example, a BMU, PCB, electromagnetic shielding, and/or other component may be placed within recesses 306-308 and/or holes 302-304 to form a rectangular shape without any protrusions. The component may then be electrically coupled to the battery cells using conductive tabs 310-316 residing within holes 302-304.

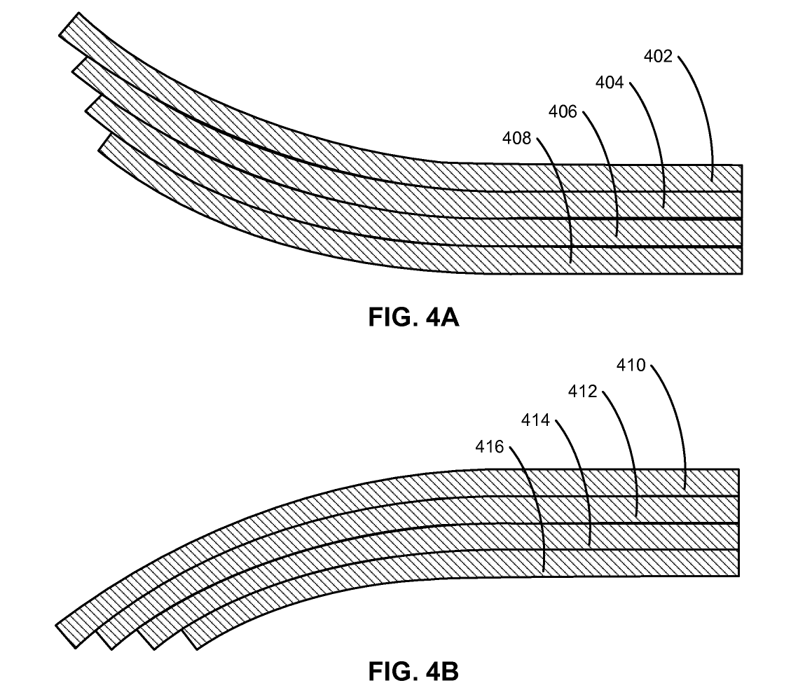

The battery cell may also have a curved shape. As shown in FIG. 4A, the battery cell may include a set of layers 402-408 formed from electrode sheets of different dimensions arranged in a stacked configuration. For example, layers 402-408 may include stacks of electrode sheets of four different sizes. A series of electrode sheets of the largest size may be stacked to form layer 402, and a series of smaller electrode sheets may be placed below layer 402 to form layer 404. A set of third-largest electrode sheets may then be stacked below layer 404 to form layer 406, and finally, the smallest electrode sheets may be placed below layer 406 to form layer 408. Such differing sizes in layers 402-408 may allow the battery cell to fit within a curved space. For example, layers 402-408 may form a terraced shape that fills a curved corner inside the portable electronic device's enclosure.

To further facilitate use of free space in the portable electronic device, an upward curve may be formed in layers 402-408. For example, the curve may increase the curvature of the battery cell over the curve formed by the horizontal stacking of layers 402-408 alone.

The battery cell may also be curved in the opposite direction from that of FIG. 4A. As shown in FIG. 4B, the battery cell may include four layers 410-416 of stacked electrode sheets of decreasing size from top to bottom, like layers 402-408 of FIG. 4A. However, layers 410-416 are curved downward instead of upward to fit the battery cell into a space with a different sort of curvature. For example, the downward curve may allow the battery cell to fit into an enclosure with a corner that is formed from a curved side and/or wall of the enclosure and a flat side and/or wall of the enclosure.

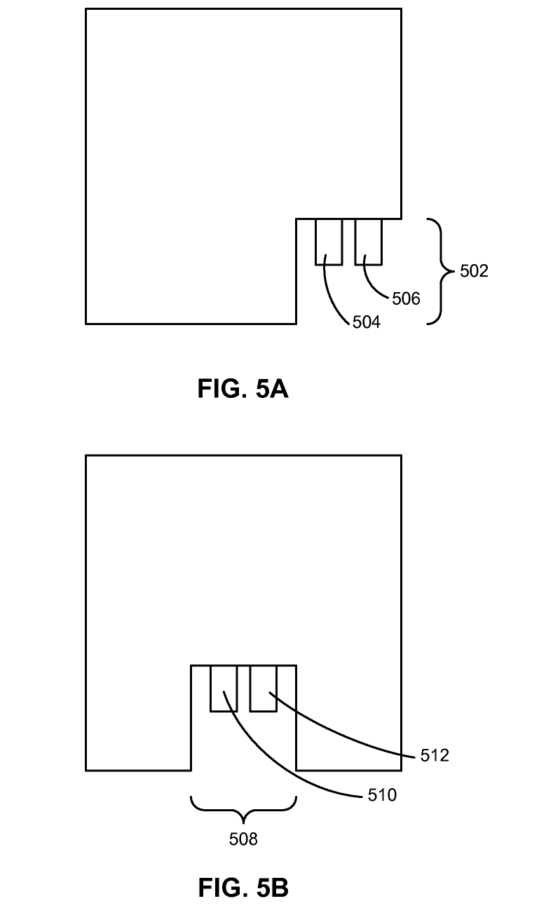

Finally, as shown in FIG. 5A, a non-rectangular shape may be produced in the battery cell by forming a notch 502 along a corner of the battery cell. A set of conductive tabs 504-506 may also be positioned within notch 502 instead of along a side of the battery cell. In turn, notch 502 and/or conductive tabs 504-506 may accommodate a component in the portable electronic device, such as a BMU, PCB, and/or electromagnetic shielding for the BMU and/or PCB. For example, the component may be placed within notch 502 to form a rectangular and/or square shape that lacks protrusions, and tabs 504-506 may be used to electrically couple the battery cell to the component and/or other battery cells in the portable electronic device.

As shown in FIG. 5B, a notch 508 may be formed along one side of the battery cell instead of at the intersection of two sides (e.g., a corner). Conductive tabs 510-512 may also be placed in notch 508 to electrically connect the battery cell to a component placed within notch 508.

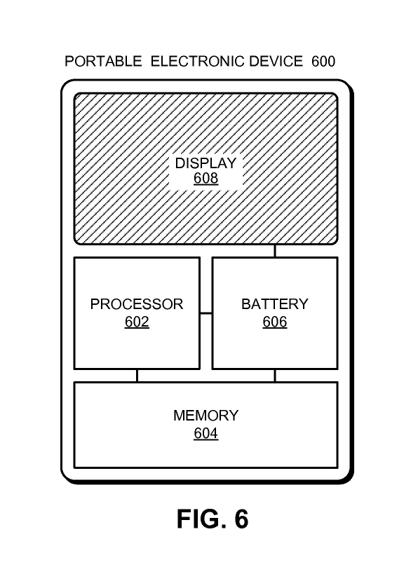

The above-described rechargeable battery cell can generally be used in any type of electronic device. For example, FIG. 6 illustrates a portable electronic device 600 which includes a processor 602, a memory 604 and a display 608, which are all powered by a battery 606. Portable electronic device 600 may correspond to a laptop computer, mobile phone, personal digital assistant (PDA), tablet computer, portable media player, digital camera, and/or other type of battery-powered electronic device. Battery 606 may correspond to a battery pack that includes one or more battery cells. Each battery cell may include a set of layers sealed in a pouch, including a cathode with an active coating, a separator, an anode with an active coating, and/or a binder coating.

The battery cell may also include a non-rectangular shape, which may include a hole extending through both the layers and the pouch and/or a recess formed along a surface of the battery cell. The non-rectangular shape may also include a set of electrode sheets of different dimensions arranged in a stacked configuration and a curve formed in the electrode sheets. Finally, the non-rectangular shape may include a notch formed along one or more sides of the battery cell.

The non-rectangular shape and/or design of the battery cell may facilitate efficient use of space in the portable electronic device. For example, the non-rectangular shape may accommodate a component in the portable electronic device, such as a BMU, PCB, and/or electromagnetic shielding. The non-rectangular shape may also allow the battery cell to fit within a non-rectangular (e.g., curved) space within the enclosure of the portable electronic device.

### Cell and Pouch Structure

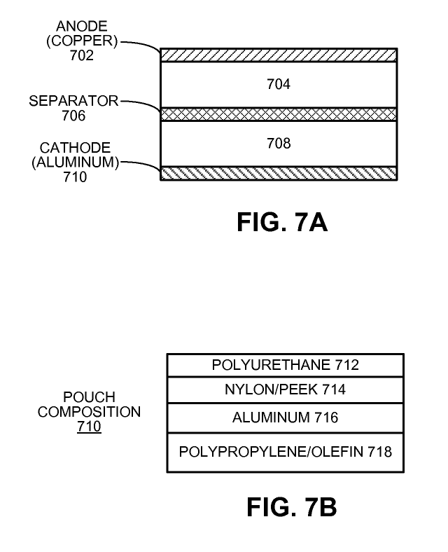

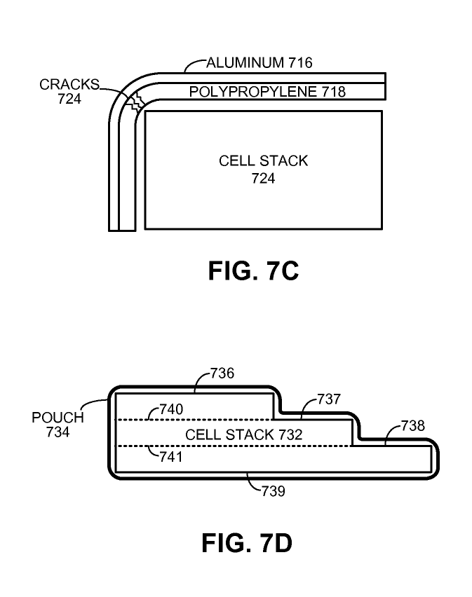

FIG. 7A illustrates an exemplary set of layers in a battery cell in accordance with the disclosed embodiments. These layers may be wound to form a jelly roll structure or can be stacked to form a stacked-cell structure. Also note that the suggested thicknesses of the layers are only provided for purposes of illustration; the layers can be thinner or thicker than the suggested thicknesses.

The illustrated layers include an anode with a copper layer 702 (which for example can be 6-10 microns thick) and a graphite layer 704 (which for example can be 50-70 microns thick). The illustrated layers also include a cathode with an aluminum layer 710 (which for example can be 10-14 microns thick) and a lithium layer 708 containing a Lithium material, such as LiCoO₂, LiNCoMn, LiCoAl or LiMn₂O₄ (which for example can be 50-70 microns thick).

A separator layer 706 is inserted between the graphite layer 704 and the lithium layer 708. For example, separator layer 706 may be 9-13 microns thick and include polyethylene (PP), polypropylene (PP), and/or a combination of PE and PP, such as PE/PP or PP/PE/PP. This separator comprises a micro-porous membrane that also provides a “thermal shut down” mechanism. If the battery cell reaches the melting point of these materials, the pores shut down which prevents ion flow through the membrane.

Separator layer 706 may also include a micro-Alumina (AL₂O₃) coating which can be single-sided or double-sided. This Alumina coating is advantageous because it provides the mechanical ruggedness of the Alumina, which is about as tough as the LiCoO₂ particles themselves. Moreover, the additional ruggedness provided by the Alumina layer can for example prevent a particle of LiCoO₂ from working its way through separator 706, which can potentially cause a shunt.

The above-described layers are immersed in an electrolyte (not shown), which for example can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel (if gelling agent are used).

FIG. 7B illustrates an exemplary set of layers in a pouch for a battery cell in accordance with the disclosed embodiments. This pouch includes a nylon and/or polyether ether ketone (PEEK) layer 714, which resides on top of an aluminum layer 716 that keeps moisture out. (Note that an adhesive may be disposed between layer 714 and layer 716, and this adhesive can include ink that acts as a colorant.) The pouch can also include an optional top layer of polyurethane 712 to reduce reflectivity and provide a matte finish. The battery pouch also includes a bottom protective layer 718 that may be polypropylene and/or olefin.

In one or more embodiments, a punch is used to form a cup in the pouch to accommodate the battery cell. Referring to FIG. 7C, during this punching process, the aluminum layer 716 tends to thin out in the corners, and the protective polypropylene layer 718 may form micro-cracks 724. When the electrolyte is subsequently put into the cell, this can create an electrical junction between the aluminum layer 716 and the cell stack 724 and cause the aluminum to go into solution to form LiAl, which is a problem.

To prevent this problem, the outermost layer of cell stack 724 should ideally be at the same potential as the aluminum layer 716. As a result, the bottom of cell stack 724 stack and the top of cell stack 724 should ideally expose an outermost aluminum cathode layer to the battery pouch. Note that to maximize volumetric efficiency, electrodes are typically single-side coated. Hence, for the bottom and top of cell stack 724, a single-side coated cathode with aluminum may be exposed against the pouch. The lack of potential difference between the aluminum layer 716 of the pouch and the aluminum of the cathode may prevent corrosion in the aluminum, even if cracks 724 are present in polypropylene layer 718.

More generally, FIG. 7D illustrates different surfaces of a non-rectangular cell stack 732 with a terraced structure in accordance with the disclosed embodiments. Note that a set of interfaces 740-741 between the terraces may either be (1) matched bare metal or (2) anode against cathode to maximize volumetric efficiency. Moreover, surfaces 736-739 of terraced cell stack 732 that are exposed against pouch 734 should ideally be aluminum cathode layers.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A battery cell, comprising:
a set of layers comprising a cathode with an active coating, a separator, and an anode with an active coating;
a pouch enclosing the layers; and
a hole extending through both the layers and the pouch to facilitate efficient use of space within a portable electronic device powered by the battery cell.

2. The battery cell of claim 1, further comprising:
a first conductive tab coupled to the cathode; and
a second conductive tab coupled to the anode,
wherein the first and second conductive tabs extend through seals in the pouch to provide terminals for the battery cell.

3. The battery cell of claim 1, further comprising:
a recess formed along a surface of the battery cell,
wherein the recess and the hole accommodate a component in the portable electronic device.

4. The battery cell of claim 3, wherein the component is a battery-management unit (BMU).

5. The battery cell of claim 1, wherein the hole is associated with at least one of a square shape, a rectangular shape, a circular shape, and an oval shape.

6. A battery cell, comprising:
a set of electrode sheets of different dimensions arranged in a stacked configuration;
a pouch enclosing the electrode sheets; and
a curve formed in the electrode sheets to facilitate efficient use of space within a portable electronic device powered by the battery cell.

7. A battery cell, comprising:
a set of layers comprising a cathode with an active coating, a separator, and an anode with an active coating;
a pouch enclosing the layers; and
a recess formed along a surface of the battery cell to facilitate efficient use of space within a portable electronic device powered by the battery cell.

8. The battery cell of claim 7, further comprising:
a hole extending through both the layers and the pouch,
wherein the recess and the hole accommodate a component in the portable electronic device.

9. The battery cell of claim 7, wherein the recess accommodates at least one of a printed circuit board (PCB) and electromagnetic shielding in the portable electronic device.

10. The battery cell of claim 7, wherein the recess is associated with at least one of a square shape, a rectangular shape, a circular shape, and an oval shape.

11. The battery cell of claim 7, wherein the recess forms a channel that extends across a length of the battery cell.

12. The battery cell of claim 7, wherein the set of layers forms a cell stack having an outermost cathode layer which is exposed against the pouch.

13. A battery cell, comprising:
a set of layers comprising a cathode with an active coating, a separator, and an anode with an active coating;
a pouch enclosing the layers; and
a notch formed along one or more sides of the battery cell to facilitate efficient use of space within a portable electronic device powered by the battery cell.

14. The battery cell of claim 13, further comprising:
a first conductive tab coupled to the cathode; and
a second conductive tab coupled to the anode,
wherein the first and second conductive tabs extend through seals in the pouch to provide terminals for the battery cell.

15. The battery cell of claim 14, wherein the first and second conductive tabs are positioned within the notch.

16. A portable electronic device, comprising:
a set of components powered by a battery pack; and
the battery pack, comprising:
a battery cell, comprising:
a set of layers comprising a cathode with an active coating, a separator, and an anode with an active coating;
a pouch enclosing the layers; and
a hole extending through both the layers and the pouch to facilitate efficient use of space within the portable electronic device.

17. The portable electronic device of claim 16, wherein the battery cell further comprises:
a first conductive tab coupled to the cathode; and
a second conductive tab coupled to the anode,
wherein the first and second conductive tabs extend through seals in the pouch to provide terminals for the battery cell.

18. The portable electronic device of claim 16, wherein the battery cell further comprises:
a recess formed along a surface of the battery cell,
wherein the recess and the hole accommodate a component in the portable electronic device.

19. The portable electronic device of claim 18, wherein the component is a battery-management unit (BMU).

20. The portable electronic device of claim 16, wherein the hole is associated with at least one of a square shape, a rectangular shape, a circular shape, and an oval shape.

21. A portable electronic device, comprising:
a set of components powered by a battery pack; and
the battery pack, comprising:
a battery cell, comprising:
a set of electrode sheets of different dimensions arranged in a stacked configuration;
a pouch enclosing the electrode sheets; and
a curve formed in the electrode sheets to facilitate efficient use of space within the portable electronic device.

22. A portable electronic device, comprising:
a set of components powered by a battery pack; and
the battery pack, comprising:
a battery cell, comprising:
a set of layers comprising a cathode with an active coating, a separator, and an anode with an active coating;
a pouch enclosing the layers; and
a recess formed along a surface of the battery cell to facilitate efficient use of space within the portable electronic device.

23. The portable electronic device of claim 22, wherein the battery cell further comprises:
a hole extending through both the layers and the pouch,
wherein the recess and the hole accommodate a component in the portable electronic device.

24. The portable electronic device of claim 22, wherein the recess accommodates at least one of a printed circuit board (PCB) and electromagnetic shielding in the portable electronic device.

25. The portable electronic device of claim 22, wherein the recess is associated with at least one of a square shape, a rectangular shape, a circular shape, and an oval shape.

26. The portable electronic device of claim 22, wherein the recess forms a channel that extends across a length of the battery cell.

27. A portable electronic device, comprising:
a set of components powered by a battery pack; and
the battery pack, comprising:
a battery cell, comprising:
a set of layers comprising a cathode with an active coating, a separator, and an anode with an active coating;
a pouch enclosing the layers, wherein the pouch is flexible; and
a notch formed along one or more sides of the battery cell to facilitate efficient use of space within the portable electronic device.

28. The portable electronic device of claim 27, wherein the battery cell further comprises:
a first conductive tab coupled to the cathode; and
a second conductive tab coupled to the anode,
wherein the first and second conductive tabs extend through seals in the pouch to provide terminals for the battery cell.

29. The portable electronic device of claim 28, wherein the first and second conductive tabs are positioned within the notch.

30. The portable electronic device of claim 27, wherein the notch accommodates a component in the portable electronic device.
